(19) United States
(12) Patent Application Publication
(10) Pub. No.: US 2026/0099122 A1
(43) Pub. Date: Apr. 9, 2026

(54) SYSTEM AND METHOD FOR HYBRID RECORDING OF 2D IMAGE AND 3D HOLOGRAM

(71) Applicant: Electronics and Telecommunications Research Institute, Daejeon (KR)

(72) Inventors: Ki Hong CHOI, Daejeon (KR); Jin Su LEE, Daejeon (KR); Kee Hoon HONG, Daejeon (KR); Hak-Rin KIM, Daegu (KR)

(73) Assignee: Electronics and Telecommunications Research Institute, Daejeon (KR)

(21) Appl. No.: 19/348,029

(22) Filed: Oct. 2, 2025

(30) Foreign Application Priority Data
Oct. 7, 2024 (KR) 10-2024-0135740
Sep. 26, 2025 (KR) 10-2025-0140308

(51) Int. Cl. G03H 1/04

(52) U.S. Cl. CPC G03H 1/0443; G03H 2001/0452; G03H 2223/20; G03H 2223/22

(57) ABSTRACT

An aspect of the present disclosure provides a hybrid recording system, wherein the hybrid recording system, with respect to incident light from a target object, comprises an objective lens, a circular polarizer, a geometric phase lens, a variable waveplate, a linear polarizer, and an image sensor that are sequentially arranged and aligned with one optical axis, and wherein the variable waveplate operates in an ON mode to convert a wavefront of two orthogonal circular polarization components that are output from the geometric phase lens into two orthogonal linear polarization components, or operates in an OFF mode.

### CROSS-REFERENCE TO RELATED APPLICATION

This application claims priority from Korean Patent Application No. 10-2024-0135740 filed on Oct. 7, 2024, and Korean Patent Application No. 10-2025-0140308 filed on Sep. 26, 2025, the disclosures of which are incorporated by reference herein in their entirety.

### TECHNICAL FIELD

The present disclosure relates to a system and method for hybrid recording of a 2D image and 3D hologram.

This work was supported by Institute of Information & communications Technology Planning & Evaluation (IITP) grant funded by the Korea government (MSIT) (No. 2019-0-00001, Development of Holo-TV Core Technologies for Hologram Media Services)

### BACKGROUND

The statements in this section merely provide background information related to the present disclosure and do not necessarily constitute prior art.

Self-interference holography captures interference patterns by self-referencing the incoherent incident light waves emitted or reflected from an object, splitting them according to spatial or polarization states. These split light waves are modulated by an interferometer or polarization modulator into wavefronts with different curvatures, which propagate to form interference patterns on the image sensor. Because this interference occurs between twin light waves originating from the same space-time, it is independent of light source conditions. Therefore, imaging is possible under fluorescent, light bulb, LED, or natural light conditions.

Self-interference requires a wavefront modulation device that splits the incident object light in half and modulates each half individually. For example, a Michelson interferometer structure may spatially separate and modulate the wavefront, then reassemble the separated and modulated wavefront to obtain a self-interference pattern.

A polarization-selective element enables wavefront modulation and interference without splitting the incident light's path in two. Representative examples include systems utilizing phase-only SLMs, birefringent lenses, liquid crystal lenses, and geometric phase lenses (GP lenses). The polarization-selective elements commonly divide the polarization of incident light into vertical and horizontal components, or left and right circular components, and modulate one or more curvatures differently for each. In particular, a geometric phase lens is a thin, passive element that acts as a concave or convex lens depending on the circular polarization of the incident light. When linearly polarized light enters, the geometric phase lens acts as a concave lens for half of the incident light and a convex lens for the other half, modulating the wavefront. Using the passive element, a self-interference digital holography system capable of reducing the system size to less than a few centimeters has been proposed.

### SUMMARY

A main object of the present disclosure is to provide a system and method for hybrid recording of a 2D image and 3D hologram using a polarization-based self-interference hologram recording system.

Objects of the present disclosure are not limited to the object mentioned above, and other objects not mentioned will be clearly understood by those skilled in the art from the description below.

According to one embodiment of the present disclosure, the 2D image and the 3D hologram can be recorded by one terminal.

Specifically, when the variable waveplate is turned ON/OFF according to user selection, diffraction calculation for hologram recording and confirmation is not required in 2D image recording mode, which saves power consumption and computing resources and reduces calculation time, enabling quick exploration of the area of interest.

Additionally, when 2D/3D hybrid content for the same scene is obtained through time division and utilized as a camera, it can be utilized to create content compatible with existing media and next-generation holographic media, and can also be utilized as a dataset for training a supervised learning deep learning network to improve hologram image quality by taking advantage of the clear 2D image video.

The effects of the present disclosure are not limited to the effects mentioned above, and other effects not mentioned will be clearly understood by those skilled in the art from the description below.

### BRIEF DESCRIPTION OF THE DRAWINGS

FIG. 1 is an exemplary diagram schematically illustrating a self-interference hologram recording system according to one embodiment of the present disclosure.

FIG. 2 is an exemplary diagram schematically illustrating a self-interference hologram recording system according to one embodiment of the present disclosure.

FIG. 3 is an exemplary diagram schematically illustrating a self-interference hologram recording system according to one embodiment of the present disclosure.

FIG. 4 is an exemplary diagram schematically illustrating a hybrid recording system according to one embodiment of the present disclosure.

FIG. 5 is an exemplary diagram illustrating a driving method of the hybrid recording system according to one embodiment of the present disclosure.

FIG. 6 is an exemplary diagram illustrating the driving method of the hybrid recording system according to one embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

Embodiments of the present disclosure relate to a system for hybrid recording of a 2D image and 3D hologram that applies a self-interference hologram recording system that obtains an interference pattern formed by self-interference of light from a target object under fluorescent, light bulb, LED, or natural light conditions.

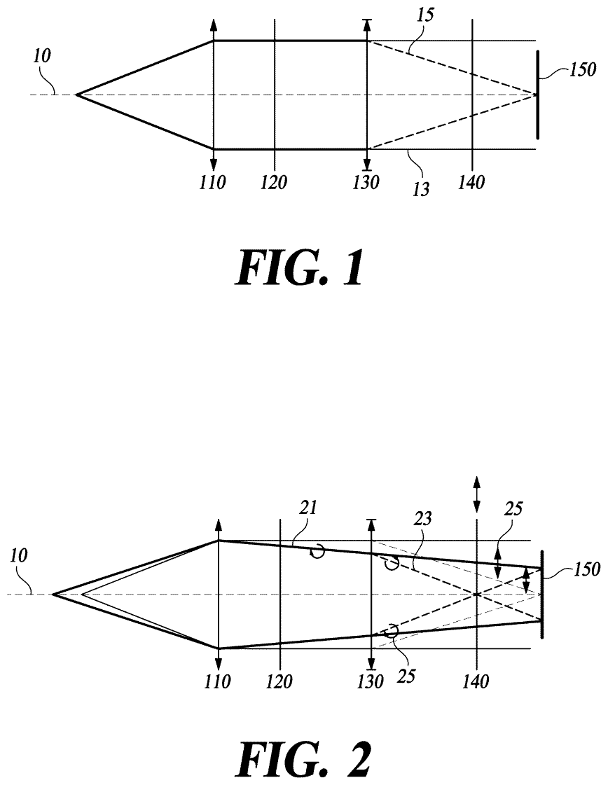

FIG. 1 is an exemplary diagram schematically illustrating a self-interference hologram recording system according to one embodiment of the present disclosure.

Referring to FIG. 1, a self-interference hologram recording system may include one or more of an objective lens 110, a circular polarizer 120, a geometric phase lens 130, a polarizer 140, or an image sensor 150. For example, the self-interference hologram recording system may obtain an interference pattern formed by self-interference from incident light. As illustrated, the objective lens 110, the circular polarizer 120, the GP lens 130, the polarizer 140, and the image sensor 150 may all be aligned along one optical axis 10.

In one embodiment of the present disclosure, the incident light is light from a target object (not illustrated), and the light source may be, for example, a fluorescent light, a light bulb, an LED, or natural light. Moreover, the target object may reflect or scatter light from these light sources or may be self-luminous, and the incident light is light reflected, scattered, or self-luminous from the target object and travels into the holographic recording system.

The image sensor 150 is a typical image sensor composed of a planar array of photodiodes whose current amount changes depending on the intensity of incident light. The photodiodes are expressed as pixels. The image sensor 150 may include a color filter. The color filter may have the form of an array in which a plurality of color filters are arranged planarly, and the color filter array may be attached to the image sensor.

In one embodiment of the present disclosure, the incident light from the target object is sequentially transmitted through the objective lens 110, the circular polarizer 120, the geometric phase lens 130, and the polarizer 140. The incident light is collected by the objective lens 110 and converted into circularly polarized light by the circular polarizer 120. The circularly polarized incident light is divided into two light waves of left-hand circular polarization and right-hand circular polarization having the same propagation direction by the geometric phase lens 130. Thereafter, the two light waves pass through the vertical polarizer 140, and only the same linearly polarization component passes through the polarizer. Therefore, the left-hand circular polarization light wave and the right-hand circular polarization light wave may interfere with each other in the same polarization state. As a result, the interference pattern is generated on the image sensor 160 and may be acquired by the image sensor 160.

The geometric phase lens 130 has both negative and positive foci. In other words, the geometric phase lens 130 has polarization selectivity and changes incident light that is right-handed circularly polarized into left-handed circularly polarized light that converges at the positive focal point, and changes incident light that is left-handed circularly polarized into right-handed circularly polarized light that diverges from the negative focal point.

The circular polarization means that the direction of vibration of the electric field vector (or magnetic field vector) of a light wave is circular vibration. Circular polarization in which the electric field vector of light rotates clockwise with respect to the observer is called right-handed circular polarization, and circular polarization in which the electric field vector rotates counterclockwise is called left-handed circular polarization.

Referring to FIG. 1, a solid line 13 and a dotted line 15, which are the light ray distributions of incident light located at the focal plane of the objective lens 110, can be confirmed. The dotted line 15 represents the wavefront of incident light imaged on the image sensor 150, and the solid line 13 may represent the wavefront of incident light that passes through the geometric phase lens 130 as is. The incident light located at the focal plane of the objective lens 110 may be imaged on the image sensor 150 after passing through the geometric phase lens 130, and the wavefront of the incident light that is not modulated by the geometric phase lens 130 may reach the image sensor 150 with a certain area.

FIG. 2 is an exemplary diagram schematically illustrating a self-interference hologram recording system according to one embodiment of the present disclosure.

Referring to FIG. 2, the self-interference hologram recording system of FIG. 2 includes the same configuration as the self-interference hologram recording system of FIG. 1, but solid lines 21 and dotted lines 23, which are the light ray distributions of incident light outside the focal plane of the objective lens 110, may be confirmed. Arrows 25 located on the light rays indicate polarization states. For example, when the solid line 21 behind the circular polarizer 120 is left-hand circular polarization, the wavefront modulated by the GP lens 130 may be right-hand circular polarization, and the unmodulated wavefront may propagate in a left-hand circular polarization state. Each wavefront may undergo self-interference on the image sensor 150 while only the vertical polarization component is filtered out by the vertical polarizer 140.

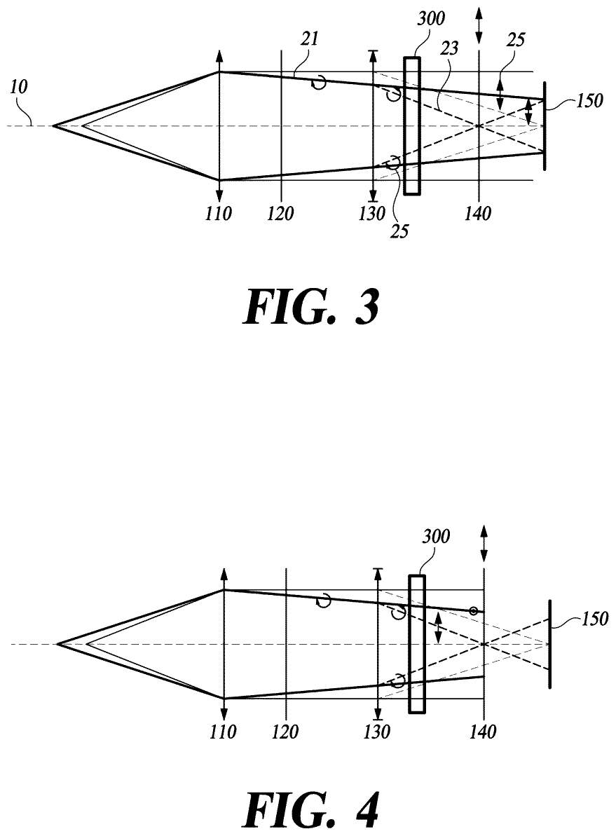

FIG. 3 is an exemplary diagram schematically illustrating a self-interference hologram recording system according to one embodiment of the present disclosure.

Referring to FIG. 3, the self-interference hologram recording system of FIG. 3 further includes a variable waveplate 300 in the same configuration as the hologram recording system of FIG. 2. Hereinafter, the self-interference hologram recording system of FIG. 3 is referred to as a “hybrid recording system”. The variable waveplate 300 may be positioned between the geometric phase lens 130 and the polarizer 140.

The variable waveplate 300 is an optical element that changes the polarization characteristics of incident light by having different refractive indices for the x and y polarization axes of light. The property that the refractive indices are different for the polarization axes is called birefringence. Using liquid crystals, the degree of birefringence may be controlled by electrical control, and the degree of birefringence may also be controlled by adjusting the angle between the active axes of two crystals. The variable waveplate 300 may have no birefringence for incident light, or may function as a Half-Waveplate (HWP) corresponding to ½ of the total wavelength or a Quarter-Waveplate (QWP) corresponding to ¼. When a linear polarization component is incident on the QWP, the component becomes circularly polarized, and when the circular polarization component is incident on the QWP, the component can become linearly polarized. When the linear polarization component is incident on the HWP, the polarization axis rotates by 90 degrees so that an orthogonal linear polarization component may be output.

The variable waveplate 300 may have an ON/OFF mode. The variable waveplate 300 may be configured to include a liquid crystal layer and electrodes, and when an electric field is applied, the arrangement of the liquid crystal molecules changes, and as a result, the difference in refractive index for two orthogonal polarization axes of incident light is adjusted. Accordingly, the ON/OFF mode of the variable waveplate 300 may be controlled depending on whether an external electric signal is applied, and through this, the user may activate or deactivate the polarization conversion function as needed.

For example, referring to FIG. 3, when the variable waveplate 300 is OFF (hereinafter, referred to as “hologram mode”), the wavefront of the incident light reaches the vertical polarizer 140 as is, and interference occurs on the image sensor 150 to record a hologram.

FIG. 4 is an exemplary diagram schematically illustrating a hybrid recording system according to one embodiment of the present disclosure.

Referring to FIG. 4, when the variable waveplate 300 is in the ON mode (hereinafter referred to as the “imaging mode”), the variable waveplate 300 may have QWP characteristics. For example, when the variable waveplate 300 operates in the QWP, the wavefronts of two orthogonal circularly polarized components are converted into two orthogonal linear polarization components, and when the converted linear polarization components reach the vertical polarizer 140, one component passes through as is, and the other component is absorbed or reflected by the polarizer. Therefore, only one component reaches the image sensor 150, so that a general 2D image acquisition system may be achieved.

For example, a zoom lens may be used instead of an objective lens 110 to vary the system's focal plane and acquire 2D images. The zoom lens may refer to a lens capable of continuously changing the focal length. A zoom lens includes multiple lens groups, and the focal length may be changed by moving the lens groups in different ways. For example, a subject may be viewed “closer” or “wider”.

The hybrid recording system may employ an in-line holographic recording method. The in-line holographic recording method involves overlapping the reference beam and object beam along the same optical axis (the direction of light propagation) without separating the reference beam and object beam at separate angles. In the in-line holographic recording method, unwanted artifacts such as bias and twin images may be generated.

The hybrid recording system may use a four-step phase shift method to eliminate bias and twin images caused by interference. For example, by rotating the linear polarizer 140 four times by 45 degrees and acquiring a hologram, a complex hologram in which the bias and twin images are removed may be obtained. The linear polarizer may convert the incident light into the linearly polarized light.

The hybrid recording system may use a polarizing image sensor instead of the linear polarizer 140. Unlike a general image sensor, the polarizing image sensor is a special image sensor that can detect not only the brightness of light but also the directionality (polarization) of light. That is, a polarizing image sensor has the advantage of being able to detect the brightness of light differently depending on the polarization state of the light by attaching polarizers with different polarization axes on the pixel array. In order to improve the quality of hologram acquisition, the pixel size should be small (high density) and the number of pixels should be large (high resolution). By acquiring a wider and more detailed interference pattern through a high-density and high-resolution image sensor, the quality of the restored hologram image may be improved.

In the hybrid recording system, when the polarized image sensors are used, it is possible to obtain complex holograms with real-time bias and twin images removed. However, in the case of the imaging mode, brightness differences may occur for each polarized pixel. In this case, a 2D image may be extracted using only vertically polarized pixel components, or, despite the brightness differences, polarized pixel components at 45 and 135 degrees may be fused in an appropriate ratio to produce a high-resolution, bright image.

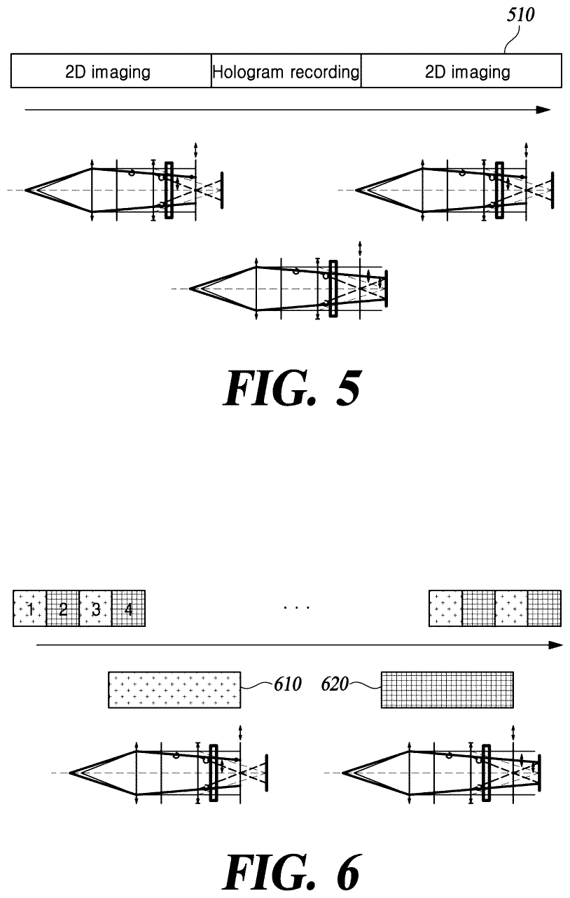

FIG. 5 is an exemplary diagram illustrating a driving method of the hybrid recording system according to one embodiment of the present disclosure.

Referring to FIG. 5, the hybrid recording system can change an operating mode 510 to imaging mode/hologram mode depending on the ON/OFF of the variable waveplate 300. For example, depending on the user's selection, the system may be generally used in imaging mode, but when a 3D hologram needs to be acquired, a 3D hologram may be acquired.

FIG. 6 is an exemplary diagram illustrating the driving method of the hybrid recording system according to one embodiment of the present disclosure.

Referring to FIG. 6, the hybrid recording system may simultaneously acquire time-division hybrid content, for example, by acquiring the 2D imaging in an odd frame 610 and the 3D hologram in an even frame 620.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A hybrid recording system,
wherein the hybrid recording system, with respect to incident light from a target object, comprises an objective lens, a circular polarizer, a geometric phase lens, a variable waveplate, a linear polarizer, and an image sensor that are sequentially arranged and aligned with one optical axis, and
wherein the variable waveplate operates in an ON mode to convert a wavefront of two orthogonal circular polarization components that are output from the geometric phase lens into two orthogonal linear polarization components, or operates in an OFF mode.

2. The hybrid recording system of claim 1, wherein when the variable waveplate is in an OFF mode,
the incident light is sequentially transmitted along a path of the optical axis through the objective lens, the circular polarizer, the geometric phase lens, and the linear polarizer, and
a 3D hologram is recorded on the image sensor by acquiring, an interference pattern formed by self-interference of the incident light.

3. The hybrid recording system of claim 1, wherein when the variable waveplate is in an ON mode,
the incident light is sequentially transmitted along a path of the optical axis through the objective lens, the circular polarizer, and the geometric phase lens, thereby generating wavefronts of two orthogonal circular polarization components, and the wavefronts are transmitted through the variable waveplate to be converted into two orthogonal linear polarization components,
the two linear polarization components are transmitted through the linear polarizer, such that one component passes therethrough, and the other component is absorbed or reflected by the linear polarizer, and
a 2D image is recorded on the image sensor using only the one component.

4. The hybrid recording system of claim 1, wherein a zoom lens can be disposed instead of the objective lens.

5. The hybrid recording system of claim 1, wherein the linear polarizer rotates 4 times at 45 degrees each.

6. The hybrid recording system of claim 1, wherein a polarization image sensor is used instead of the linear polarizer and image sensor.

7. The hybrid recording system of claim 1, wherein operation in one of the ON mode or the OFF mode is performed by controlling the variable waveplate to be in the ON mode or the OFF mode on a time frame basis, so that time-division hybrid content can be recorded.

8. A hybrid recording method, comprising:
sequentially transmitting incident light along a path of the optical axis from a target object through an objective lens, a circular polarizer, a geometric phase lens, a variable waveplate, a linear polarizer, and an image sensor arranged with one optical axis; and
controlling the variable waveplate to operate in an ON mode, in which a wavefront of two orthogonal circular polarization components output from the geometric phase lens into two orthogonal linear polarization components, or in an OFF mode.

9. The hybrid recording method of claim 8, wherein when the variable waveplate is in the OFF mode,
the incident light is sequentially transmitted along the path of the optical axis through the objective lens, the circular polarizer, the geometric phase lens, and the linear polarizer, and
a 3D hologram is recorded by acquiring, on the image sensor, an interference pattern formed by self-interference of the incident light.

10. The hybrid recording method of claim 8, wherein when the variable waveplate is in the ON mode,
the incident light is sequentially transmitted along a path of the optical axis through the objective lens, the circular polarizer, and the geometric phase lens, thereby generating wavefronts of two orthogonal circular polarization components, and the wavefronts are transmitted through the variable waveplate to be converted into two orthogonal linear polarization components,
the two linear polarization components are transmitted through the linear polarizer, such that one component is transmitted as is, and the other component is absorbed or reflected by the linear polarizer, and
a 2D image is recorded on the image sensor using only the one component.

11. The hybrid recording method of claim 8, wherein a zoom lens can be used instead of the objective lens.

12. The hybrid recording method of claim 8, wherein the linear polarizer rotates 4 times at 45 degrees each.

13. The hybrid recording method of claim 8, wherein a polarization image sensor is used instead of the linear polarizer and the image sensor.

14. The hybrid recording method of claim 8, wherein controlling operation in one of an ON mode or an OFF mode is performed by controlling the variable waveplate to be in the ON mode or the OFF mode in units of time frames so that time-division hybrid content can be recorded.
